(19) United States
(12) Patent Application Publication
(10) Pub. No.: US 2005/0044715 A1
(43) Pub. Date: Mar. 3, 2005

(54) Stripping tool for fiber optic cables

(75) Inventors: Leslie B. Shutts, Ruther Glen, VA (US); Yin Ho Cheng, Taipei Hsien (TW); Huang De Sei, Taipei Hsien (TW)

Correspondence Address: LAWRENCE E. LAUBSCHER, SR.;LAUBSCHER LAW OFFICES, 1160 SPA ROAD, SUITE 2B, ANNAPOLIS, MD, 21403, US

(73) Assignee: Connectool Inc., Ashland, VA (US)

(21) Appl. No.: 10/646,683

(22) Filed: Aug. 25, 2003

(51) Int. Cl. H02G 1/12

(52) U.S. Cl. 30/90.1; 30/91.2; 81/9.44

(57) ABSTRACT

A scissors-type fiber optic cable stripping tool includes a pair of operating members pivotally connected intermediate their ends, thereby to define stripping portions and handle portions on opposite sides of a pivot pin. The adjacent surfaces of the stripping portions are provided with a plurality of longitudinally spaced V-shaped recesses that cooperate when the operating members are pivoted to the closed position to define stripping openings that progress in size in the direction away from the pivot pin. Spring means bias the operating members toward an open condition, and locking means serve to lock the operating members in the closed condition for transport of the tool. The stripping openings of progressively increasing size have machined surfaces that define knife edges are adapted to sever the outer concentric insulation layers of various sizes and types of fiber optic cables, including the outer jacket of a 2.0 mm to 2.4 mm optic fiber cable, the outer jacket of a 2.8 to 3.0 mm optic fiber cable, the outer jacket of a 2.0 mm to 3.0 mm loose tube optic fiber cable, the 900 μm buffer layer of a loose buffer optic cable, and the buffer and acrylate layers of 900/125 μm and 250/125 μm fiber optic cables.

### FIELD OF THE INVENTION

A versatile scissors-type stripping tool for removing the outer layer of insulation from a plurality of types and sizes of optic fiber cables, including a pair of operating members that are pivotally connected intermediate their ends to define on each operating member on opposite sides of a pivot pin a stripping portion and a handle portion. A plurality of recesses having knife edges are provided longitudinally on the adjacent sides of the stripping portions, which recesses cooperate when the operating members are in the closed condition to define stripping openings the size of which progressively increases in the direction away from the pivot pin.

### BACKGROUND OF THE INVENTION

### BRIEF DESCRIPTION OF THE PRIOR ART

Insulation stripping tools for stripping insulation from electrical conductors are well known in the patented prior art, as shown by the inventors's prior U.S. Pat. No. 6,526,661, which is assigned to the same assignee as the present invention. Of course, the problem of stripping insulation layers from optic fiber cables is more difficult than the stripping of insulation from electrical conductors, since the glass cores and the glass cladding layers are rather brittle and delicate. Also, the glass core and cladding layers are quite small and thin, and different sizes of stripping tools are normally required in the field to effect the appropriate stripping operation required for the various sizes of fiber optic cables. Hence much greater precision is required in stripping the insulation layers from the glass core.

### SUMMARY OF THE INVENTION

Accordingly, the present invention was developed to provide a universal multi-function fiber optic stripping tool that offers unsurpassed ergonomics, comfort and reliable stripping accuracy for multiple fiber cable types.

A primary object of the present invention is to provide a universal stripping tool for stripping one or more layers of insulation from various sizes of fiber optic cables. A scissors-type hand tool includes a pair of operating members that are pivotally connected between their ends to define on opposite sides of the pivot pin a pair of stripping portions and a pair of handle portions, respectively. The adjacent surfaces of the stripping portions contain a plurality of opposed longitudinally-spaced V-shaped recesses that cooperate when the operating arms are in the closed condition to define a series of stripping openings the sizes of which progressively increase in the direction away from the pivot pin. The V-shaped recesses are formed in parallel chamfered surfaces formed on the adjacent edges of the high carbon steel stripping portions, knife edges being formed on the recesses by grinding with the use of a diamond-faced rotary tool. Thus, when a cable is inserted into a recess with the operating members in the open condition, the greater the distance of the stripping opening from the pivot pin, the greater is the severing torque applied by the knife edges to the outer insulation layers of the cable during the pivotal movement of the operating members toward the closed condition.

According to a further object of the invention, the operating members are spring-biased toward the open condition by a compression spring arranged between the handle portions of the operating members. Factory-adjusted calibration means limit the extent of relative displacement of the operating members in the direction of the closed condition. Furthermore, the housing of the calibration means limits the extent of relative displacement in the operating members in the spring-biased opening direction of displacement. For safety during transport, locking means are provided for locking together the operating members when in the closed condition.

The universal fiber optic stripping tool according to the present invention is quite versatile and affords reliable stripping accuracy for multiple optic fiber cable assemblies, the removal of the outer jackets from 2.0 mm to 2.4 mm optic fiber cables and 2.8 mm to 3.0 mm optic fiber cables, the outer jackets from 2.0 mm to 3.0 mm loose tube optic fiber cables, the stripping of the 900 μm buffer layer of a loose buffer without removal of the acrylate layer, and the stripping of the buffer and acrylate layers off of 900/125 μm and 250/125 μm optic fibre cables.

### BRIEF DESCRIPTION OF THE DRAWINGS

Other objects and advantages of the invention will become apparent from a study of the following specification when viewed in the light of the accompanying drawings, in which:

FIG. 1 is a left hand elevational view of the optic cable stripping tool of the present invention, when in the closed condition;

FIG. 2 is a right hand elevational view of the tool of FIG. 1 when in the open condition;

FIG. 3 is a detailed view of the stripping portion of the tool of FIG. 1;

FIGS. 4 and 5 are diagrammatic side elevation and end views, respectively, illustrating the structure of a first fiber optic cable with a glass fiber core;

FIGS. 6 and 7 are side elevation and end views, respectively, of a partially stripped loose tube multi-fiber optic cable;

FIGS. 8 and 9 are side elevation and end views of a partially stripped loose buffer fiber optic cable;

FIG. 10 is a sectional view taken along line 10-10 of FIG. 3;

FIG. 11 is a sectional view taken along line 11-11 of FIG. 2; and

FIG. 12 is a sectional view taken along line 12-12 of FIG. 1.

### DETAILED DESCRIPTION

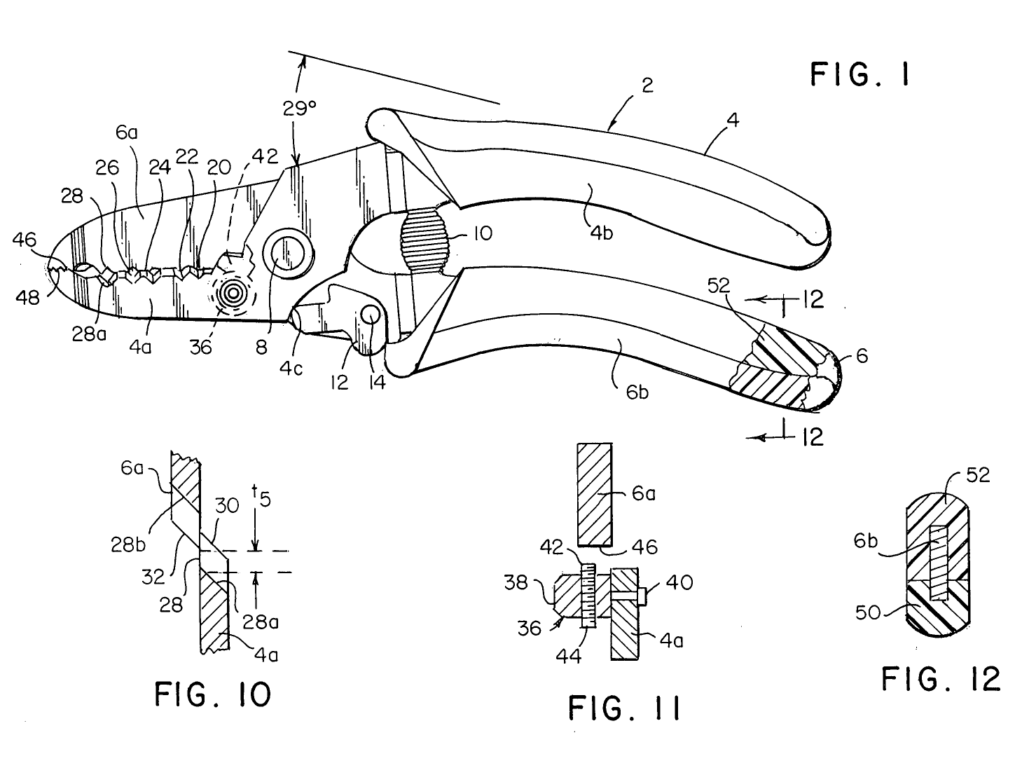

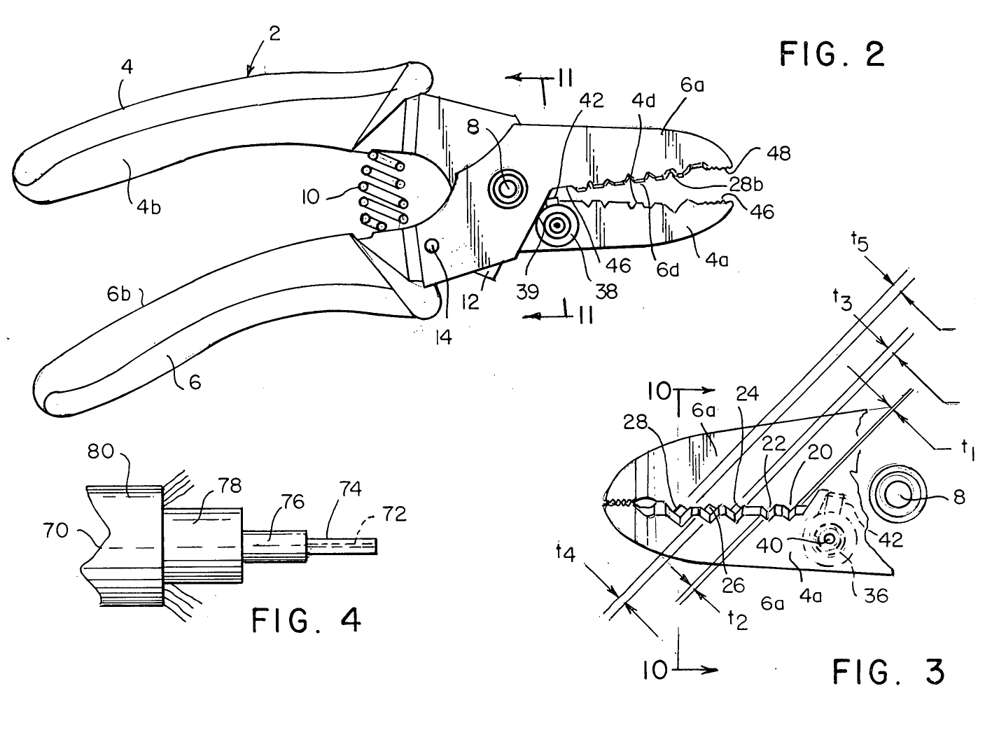

Referring first more particularly to FIGS. 1 and 2, the fiber optic stripping tool 2 includes a pair of operating members 4 and 6 that are pivotally connected intermediate their ends by pivot pin 8, thereby to permit pivotal displacement of the members between the closed condition of FIG. 1 and the open condition of FIG. 2. The operating members are formed of a hard metal, such as high carbon steel. A pair of stripping portions 4a and 6a are formed on one side of the pivot pin 8, and a pair of handle portions 4b and 6b are defined on the opposite side of the pivot pin. Compression spring 10 normally biases the operating members apart toward the open condition of FIG. 2. As shown in FIG. 1, an L-shaped locking lever 12 is pivotally connected by a second pivot pin 14 between a locked condition shown in FIG. 1, to an unlocked condition shown in FIG. 2. When in the locked condition of FIG. 1, the locking member engages the stop surface 4c on the operating arm 4, thereby to lock the same in the illustrated closed condition.

In accordance with a characterizing feature of the present invention, the adjacent surfaces of the stripping portions 4a and 6a are provided with a succession of V-shaped recesses that cooperate to define stripping openings 20, 22, 24, 26, and 28 when the operating members are in the closed condition of FIG. 1. These stripping openings progressively increase in size in the direction away from the pivot pin 8, as will be described in greater detail below.

Referring now to FIGS. 3 and 10, the adjacent edges of the stripping portions 4a and 6a are chamfered to define parallel chamfered surfaces 30 and 32 that have the same angle of inclination, whereby the tool is designed for operation by a right-handed person. For left-handed use, the tools would have the opposite angle of inclination. Provided in the chamfered surfaces are a plurality of longitudinally spaced recesses that cooperate to define the stripping openings. For example, the stripping opening 28 is defined by the V-shaped recesses 28a and 28b formed in the adjacent surfaces 4d and 6d, respectively, of the stripping portions 4a and 6a, as best shown in FIG. 2. The chamfered surfaces 30 and 32 and the flat walls of the V-shaped recesses that define the stripping openings are accurately machined by precision diamond head grinding tool means, as is known in the art. In order to accurately position the stripping portions 4a and 6a when the operating members are in the closed condition of FIG. 1, calibration means 36 are provided for limiting the extent of travel of the operating members toward the closed position. Thus, as best shown in FIG. 11, the calibration means 36 includes a calibration member 38 that is rigidly secured to the stripping portion 4a of the operating member 4 by means of a rivet 40, or the like. A set screw 42 having a hex head 44 is threadably adjustable relative to the calibration body 38 relative to the corresponding calibration surface 46 on the stripping portion 6a of the operating member 6. The calibration is factory set to assure precision adjustable calibration, whereby the stripping opening dimensions are adjusted within tolerance for stripping accuracy. As shown in FIG. 2, the calibration body 38 also serves as a stop that is engaged by stop surface 39 on the operating member 6, thereby to limit the extent of relative travel of the operating members in the open condition. Serrated crimping surfaces 46 and 48 are provided at the free extremities of the stripping portions 4a and 6a, respectively, as best shown in FIG. 2.

As shown in FIG. 12, the handle portions of the operating members 4 and 6 are covered with protective cushioning layers 50 and 52, such as urethane foam, thereby to soften the grip of the tool to the hand of the user. Furthermore, the adjacent edges of the portions 4a and 6a when the operating members are in the FIG. 1 closed condition extend at an acute angle of about 29° to the axes of the operating member, as shown in FIG. 1, thereby to prevent the user from carpel tunnel syndrome over repeated use.

In accordance with a characterizing feature of the present invention as best shown in FIG. 3, the sizes of the stripping openings 20, 22, 24, 26, and 28 progressively increase in the direction away from the pivot pin 8, as shown by the thicknesses t₁, t₂, t₃, t₄, and t₅, respectively. Thus, the illustrated tool is a five-way universal stripping tool for stripping the insulation layers of five different sizes of fiber optic cables. In the illustrated embodiment, the tool is suitable for use with fiber optic cables of standard sizes of 2.0 mm, 2.4 mm, 2.8 mm, 3.0 mm fiber optic cables with a 900 μm buffer layer, with a 250 μm acrylate layer, and 125 μm glass cladding layer with a 62.5 μm or 50 μm internal glass pore.

Referring now to FIGS. 4 and 5, the fiber optic cable 70 includes a 50 μm or 62.5 μm glass core 72, having a 125 μm glass cladding layer 74. Circumferentially arranged about the glass cladding layer is a 250 μm acrylate coating layer 76 upon which is arranged an annular 9001m buffer insulation layer 78. An outer jacket 80 of Kevlar strands is arranged concentrically about the buffer insulation layer 78, which outer jacket layer 80 has a dimension of 2.0 mm, 2.4 mm, or 3.0 mm. To remove the outer jacket from the cable 70 of FIGS. 4 and 5, the cable is introduced within the third stripping opening, whereupon the operating members 4 and 6 are pivoted to the closed position to effect severing of the outer jacket layer 80 by the knife edges of the opening 24. Similarly, if the cable 70 had a diameter of between 2.8-3.0 mm, the cable would be introduced within the fifth opening identified as “2.8-3.0 mm OJ.” In this case, the outer jacket would be severed and longitudinally removed from the cable. In order to remove simultaneously both the 900 μm buffer layer as well as the 250 μm Acrylate layer from the cable, the cable would be introduced within the first stripping opening 20 and the operating members would be closed to sever the buffer and Acrylate layers, wherein the severed insulation portions would simultaneously longitudinally displace from the cable.

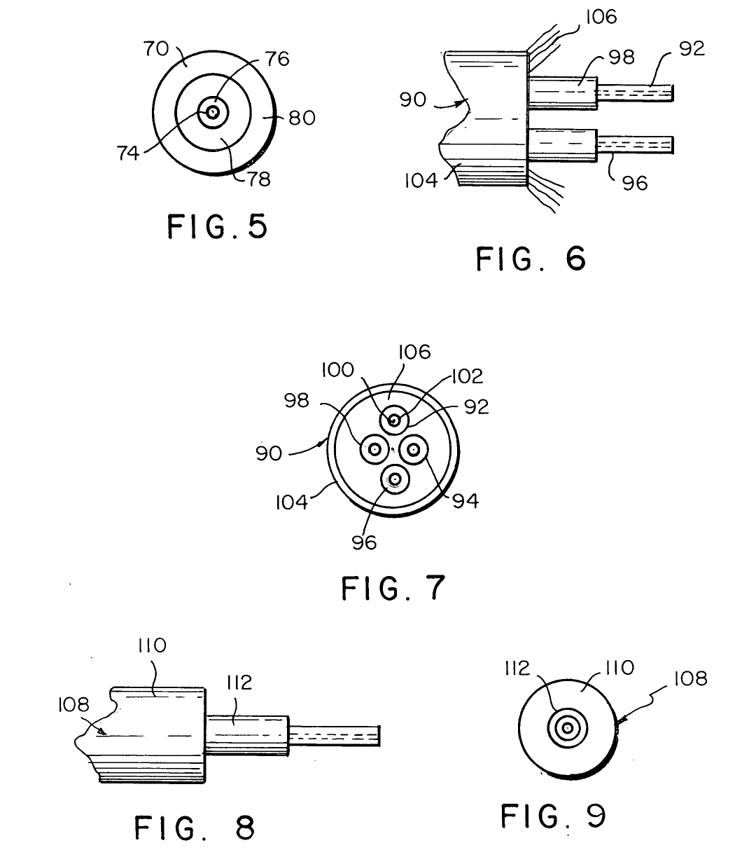

Referring now to FIGS. 6 and 7, the loose tube multi-optic fiber cable 90 contains four glass core optical fiber elements 92, 94, 96, and 98, each of which includes a 50 μm or 62.5 μm glass core 100 surrounded by a 125 μm glass cladding 102 that is contained within an outer jacket 104, the space between the cables and the jacket being filled Kevlar strands 106. The outer diameter of the outer jacket 104 has a dimension of 2.0 mm to 3.0 mm. To remove the outer jacket 104 for cables having a diameter of 2.0 mm to 3.0 mm, the cable to be stripped is introduced within the fourth stripping opening 26, whereupon the operating members 4 and 6 are closed to sever the outer jacket, whereupon the severed portion is longitudinally removed from the cable. To remove the 250 μm Acrylate layer, the cable is then introduced within the first opening 20, and the operating members 4 and 6 are closed to sever the Acrylate layer, with the severed portion then subsequently longitudinally displaced from the cable.

Finally, with regard to the cable of FIGS. 8 and 9, the 900 μm loose buffer fiber optic cable 108 is stripped as follows. First, the cable is introduced within the second stripping opening 22 (the “900 μm Buffer only” opening), and the operating members are closed to sever the buffer layer 110 which layer is then longitudinally displaced from the cable. To remove the 250 μm Acrylate coating layer 112, the cable is introduced within the first stripping opening 20, and upon closing of the operating members, this Acrylate layer is severed, and then is longitudinally removed from the cable.

The stripping tool of the present invention is unique in that it will strip almost every size, type, and construction of fiber optic cable up to 3.0 mm diameter without damaging the cables. It is the only tool where one tool strips everything. Other tools in the art typically will either strip the buffer and be Acrylate layer without stripping the jacket, or they will strip the jacket but not the buffer and the Acrylate layers. The present tool is unique in that it strips both loose tube and loose buffer cables, and no other tool is required. Thus, the five separate stripping areas afford a precision set for specific stripping functions.

Owing to the 29° angle illustrated in FIG. 1, the multi-function fiber optic stripping tool offers unsurpassed ergonomics, comfort, and reliable stripping accuracy for multiple fiber cable types. The tool is factory set and calibrated to ensure optimum performance, and the high carbon steel construction affords the desired longevity and reliability. The locking handle feature affords safety during transport, and the fully ergonomic rubber angled-handles prevent wrist bending and provide comfort over repeated use.

While in accordance with the provisions of the Patent Statutes the preferred forms and embodiments of the invention have been illustrated and described, it will be apparent to those skilled in the art that various changes and modifications may be made without deviating from the inventive concepts set forth above.

1. A fiber optic cable stripping tool for removing a layer of insulation from a fiber optic cable having an optical glass core, an annular glass cladding layer arranged concentrically about the core, and at least one annular layer of insulation arranged about the glass cladding layer, comprising:
(a) first and second operating members pivotally connected intermediate their ends by a pivot pin, thereby to define on opposite sides of said pivot pin a pair of handle portions and a pair of stripping portions, respectively, said operating members being pivotally displaceable between closed and open conditions in which adjacent surfaces of said stripping portions are adjacent and separated from each other, respectively;
(b) spring means normally biasing said operating members apart toward said open condition; and
(c) means defining a plurality of opposed longitudinally-spaced stripping recesses in each of the adjacent faces of said stripping portions, said stripping recesses cooperating when said operating members are in said closed condition to define a plurality of stripping openings that progressively increase in size in the direction away from said pivot pin, the walls of each of said stripping recesses being relieved to define sharp knife edges, whereby when the operating members are in the open condition and a fiber optic cable is inserted within a recess of corresponding size, displacement of said operating members to said closed condition causes said knife edges to sever at least the outer layer of insulation, thereby to permit the longitudinal removal of the severed insulation portion from the cable.

2. A stripping tool for fiber optic cables as defined in claim 1, and further including:
(d) adjustable calibration means for limiting the extent of travel of said first operating member in the direction of said second operating member, thereby to control the relative positions of said operating members when in the closed insulation-severing condition.

3. A stripping tool for fiber optic cables as defined in claim 2, wherein said calibration means includes:
(1) a calibration body secured to the stripping portion of one of said operating members adjacent said pivot pin, said calibration body extending adjacent the other of said operating members in a direction parallel with said pivot axis, and
(2) a calibrating screw threadably mounted for axial adjustment in a through bore contained in said calibration body, said calibrating screw extending toward the other of said operating members for engagement with a first stop surface carried thereby.

4. A stripping tool for fiber optic cables as defined in claim 3, wherein said calibration body is arranged to engage a second stop surface on said other operating member to limit the travel thereof toward the open condition.

5. A stripping tool for fiber optic cables as defined in claim 2, wherein the remote edges of the adjacent surfaces of said stripping portions of said operating members are chamfered to define a pair of parallel chamfered surfaces each containing said recesses, and further wherein each of said recesses is V-shaped and includes a pair of flat side walls, respectively.

6. A stripping tool for fiber optic cables as defined in claim 5, wherein the apices defined between the side walls of said V-shaped recesses are parallel.

7. A stripping tool for fiber optic cables as defined in claim 6, wherein each of said operating members is formed of stainless steel; and further wherein each of said recess wall surfaces and each of said chamfered surfaces is formed by grinding with a precision diamond head rotary grinding tool.

8. A stripping tool for fiber optic cables as defined in claim 2, and further including:
(e) locking means for locking together said operating members when said locking members are in said closed condition.

9. A stripping tool for fiber optic cables as defined in claim 8, wherein said locking means comprises a generally L-shaped locking member pivotally connected to one of said operating members, said locking member being pivotally operable between locked and unlocked positions relative to a locking surface on the other of said operating members.

10. A stripping tool for fiber optic cables as defined in claim 9, wherein said locking lever is arranged near said pivot pin for operation by the forefinger of a user of said stripping tool.

11. A stripping tool for fiber optic cables as defined in claim 2, and further including gripping means defined on the adjacent surfaces of the free extremities of said stripping portions for gripping an article placed therebetween when said operating members are displaced from said open condition toward said closed condition.

12. A stripping tool for fiber optic cables as defined in claim 2, wherein when the operating members are in the closed condition, the adjacent surfaces of the stripping portion arranged at an angle of about 29° relative to the longitudinal axes of the handle portion, thereby to avoid wrist bend and to prevent carpal tunnel syndrome over repeated use.

13. A stripping tool for fiber optic cables as defined in claim 12, wherein each of said handle portions includes a cushioned outer hand-grip layer.

14. A stripping tool for fiber optic cables as defined in claim 2, wherein the size of the first cable stripping opening adjacent said pivot pin is such as to sever simultaneously a 900 μm buffer insulation layer and a 250 μm acrylate layer for the longitudinal stripping thereof off of a 2.0 mm to 3.0 mm fiber optic cable having a 50 μm to 62.5 μm glass core.

15. A stripping tool for fiber optic cables as defined in claim 14, wherein the size of the adjacent second cable stripping opening is such as to sever the 900μ buffer insulation layer for the longitudinal stripping thereof off of the fiber optic cable.

16. A stripping tool for fiber optic cables as defined in claim 15, wherein the size of the adjacent third cable stripping opening is such as to sever the outer insulation jacket for the stripping thereof off of a 2.0 to 2.4 mm fiber optic cable.

17. A stripping tool for fiber optic cables as defined in claim 16, wherein the size of the adjacent fourth cable stripping opening is such as to sever the outer insulation jacket for the stripping thereof off of a 2.0 to 3.0 mm loose tube multiple fiber optic cable.

18. A stripping tool for fiber optic cables as defined in claim 17, wherein the adjacent fifth stripping opening is of such a size as to sever the outer insulation jacket of a 2.8 mm to 3.0 mm fiber optic cable.
